(19) United States
(12) Patent Application Publication
(10) Pub. No.: US 2019/0138979 A1
(43) Pub. Date: May 9, 2019

(54) SYSTEM AND METHOD FOR INTEGRATING INTERMEDIARY AND END-USER ONLINE RETAIL EXPERIENCES

(71) Applicants: Gregory Forgatch, San Marino, CA (US); Lorraine Forgatch, San Marino, CA (US); Karen Preston, San Marino, CA (US); Grant Wenzlau, Los Angeles, CA (US)

(72) Inventors: Gregory Forgatch, San Marino, CA (US); Lorraine Forgatch, San Marino, CA (US); Karen Preston, San Marino, CA (US); Grant Wenzlau, Los Angeles, CA (US)

(21) Appl. No.: 16/026,845

(22) Filed: Jul. 3, 2018

Related U.S. Application Data
(63) Continuation of application No. 14/944,172, filed on Nov. 17, 2015, now abandoned.
(60) Provisional application No. 62/080,765, filed on Nov. 17, 2014.

(51) Int. Cl. G06Q 10/08; G06Q 30/06; G06Q 30/02

(52) U.S. Cl. CPC G06Q 10/087; G06Q 30/0201; G06Q 30/0643

(57) ABSTRACT

A network connected system for inventory management is disclosed including an intermediary module, including providing sales and inventory management functions for intermediaries such as wholesalers and retailers and an end-user module, including providing sales to end-users using an end-user identifier which is associated with a wholesaler or retailer.

### RELATED APPLICATIONS

This filing is a continuation of U.S. patent application Ser. No. 14/944,172, filed Nov. 17, 2015, which claims the benefit of and priority to U.S. Provisional Patent Application No. 62/080,765, filed Nov. 17, 2014, both of which is incorporated by reference herein in their entireties and for all purposes.

### FIELD OF THE INVENTION

The field of the invention relates to a system and methods for an online boutique and wholesale shopping portal.

### BACKGROUND OF THE INVENTION

Online commerce is typically structured as a producer selling either to wholesalers, retailers or end-users. Selling solely to wholesalers can be inefficient because producers may derive additional sales by selling directly to retailers and end-users who may wish to purchase directly from producers. Similarly, selling solely to retailers and end-users can be inefficient because producers may derive additional sales by selling to wholesalers which may have broader sales channels.

Often, the only way for a small retailer to offer their products to their customers is in a brick-and-mortar store. In many cases there may be no digital integration between a retailer's inventory and online shopping for customers. Even when there is a digital integration between a retailer's inventory and online shopping for customers, it typically takes the form of a consumer purchasing items online and having the items shipped directly to the consumer or to a consumer's nearest retail establishment for in-store pickup under the consumer's name, address, credit card information or phone number.

One current method for wholesalers and retailers to place orders generally consist of pen and paper, such as marking on a print catalog. Other methods include wholesalers and retailers using static online tools or websites rather than interacting with a sales representative in real-time to build an order in a sandbox-type environment. Sales representatives can assist in calculating costs and matching orders so that the orders are well balanced and within the wholesaler or retailer's budget.

Due to the lack of digital integration between wholesaler and retailer inventories and online shopping for customers, order fulfillment typically occurs by placing a special order through a retailer. This usually requires the customer requesting that the retailer contact the producer. Subsequently, the retailer would call the producer place a special order for the customer.

As such, it is beneficial to create a unified online wholesaler, retailer and end-user shopping environment including the advantages of greater efficiency, lower cost to wholesalers, retailers and consumers, higher sell-through, greater customer engagement and improved wholesaler and end-user relationships.

### SUMMARY

Provided herein are example embodiments of systems, devices and methods for facilitating improved user and intermediary use of a network connected web server system including inventory and customized recommendations and webpages. Other improvements and advantages are provided as well. The various configurations of these systems, devices and methods including variations are described in detail by way of the embodiments which are only examples.

Other systems, devices, methods, features and advantages of the subject matter described herein will be or will become apparent to one with skill in the art upon examination of the following figures and detailed description. It is intended that all such additional systems, devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE DRAWING(S)

Illustrated in the accompanying drawing(s) is at least one of the best mode embodiments of the present invention In such drawing(s):

FIG. 1A shows a typical network architecture in accordance with the present invention.

FIG. 1B shows a client-server interface according to an example embodiment of the present invention.

FIG. 1C shows a mobile purchase device with installed purchase application according to an embodiment of the present invention.

FIG. 2 shows an intermediary selection and order placement flowchart according to an embodiment of the present invention.

FIG. 3 shows an end-user purchasing flowchart according to an embodiment of the present invention.

FIG. 4A shows a wireframe of a wholesaler login page according to an example embodiment of the present invention.

FIG. 4B shows a wireframe of a wholesaler homepage according to an example embodiment of the present invention.

FIG. 5A shows a wireframe of a wholesaler item selection screen according to an example embodiment of the present invention.

FIG. 5B shows a wireframe of a wholesaler item selection screen with items selected according to an example embodiment of the present invention.

FIG. 5C shows a wireframe of a comprehensive retail items page according to an embodiment of the present invention.

FIG. 5D shows a wireframe of a product detail page according to an embodiment of the present invention.

FIGS. 6A-6B show a wireframe of a selected items page according to an example embodiment of the present invention.

FIGS. 7A-7B shows a wireframe of an orders page according to an example embodiment of the present invention.

FIG. 8 shows a wireframe of an order confirmation page according to an example embodiment of the present invention.

FIG. 9 shows a wireframe of a wholesaler order placement screen according to an example embodiment of the present invention.

FIGS. 10A-10C show wireframes of a wardrobe extender according to an example embodiment of the present invention.

FIGS. 11A-11E show wireframes of an online boutique according to an example embodiment of the present invention.

### DETAILED DESCRIPTION

Various exemplary embodiments are described below. Reference is made to these examples in a non-limiting sense, as it should be noted that they are provided to illustrate more broadly applicable aspects of the devices, systems and methods. Various changes may be made to these embodiments and equivalents may be substituted without departing from the true spirit and scope of the various embodiments. In addition, many modifications may be made to adapt a particular situation, process, process act or step, system, component, or other related structure without departing from the objectives, spirit and scope of the present invention. All such modifications are intended to be within the scope of the claims made herein.

Before the present subject matter is described in detail, it is to be understood that this disclosure is not limited to the particular example embodiments described, as such may vary. It is also to be understood that the terminology used herein is for the purpose of describing particular example embodiments only, and is not intended to be limiting, since the scope of the present disclosure will be limited only as described by the limitations of the appended claims.

All features, elements, components, functions, and steps described with respect to the embodiments provided herein are intended to be freely combinable and substitutable with those from any other embodiment as would be understood by one of skill in the art to accomplish the objectives described herein. If a certain feature, element, component, function, or step is described with respect to only one embodiment, it should be understood that such feature, element, component, function, or step can be used with many or all other embodiments described herein unless explicitly stated otherwise or unless such usage would compromise functionality of the particular system or method for its intended purpose. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. Express recitation of every possible combination and substitution is overly burdensome, especially given that the permissibility that such combinations and substitutions will be readily recognized by those of ordinary skill in the art upon reading this description.

The present invention will be described with respect to an example embodiment of a golf apparel producer. However, it should be understood that the example embodiment is not limiting with respect to the types of producers which may implement the current invention. For instance, an automotive-parts producer, a candle manufacturer, a photography studio or any number of other types of producers, manufacturers and retailers may implement the invention described herein.

In an example embodiment of the system, two portions of a website are integrated. A first portion is a web interface for wholesalers which allows selection of items to create orders in real-time with optional sales representative communication. A related product section can provide wholesalers with suggestions for associated products, such that a collection of items for the wholesaler to offer to consumers will be unified and have the potential to be more successful. A second portion is a web interface for wholesalers or retailers to introduce to consumers such that the consumers, also referred to herein as end users, can access a larger product offering without additional inventory cost to the wholesaler.

Mobile applications, mobile devices such as smart phones/tablets, application programming interfaces (APIs), databases, social media platforms including social media profiles or other sharing capabilities, load balancers, web applications, page views, networking devices such as routers, terminals, gateways, network bridges, switches, hubs, repeaters, protocol converters, bridge routers, proxy servers, firewalls, network address translators, multiplexers, network interface controllers, wireless interface controllers, modems, ISDN terminal adapters, line drivers, wireless access points, cables, servers and others equipment and devices as appropriate to implement the method and system is contemplated.

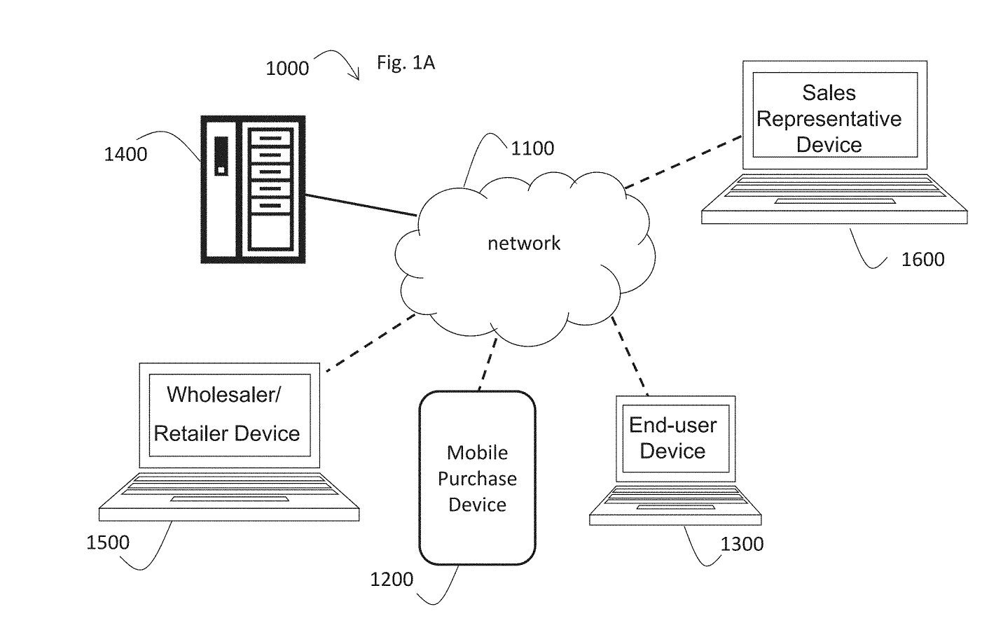

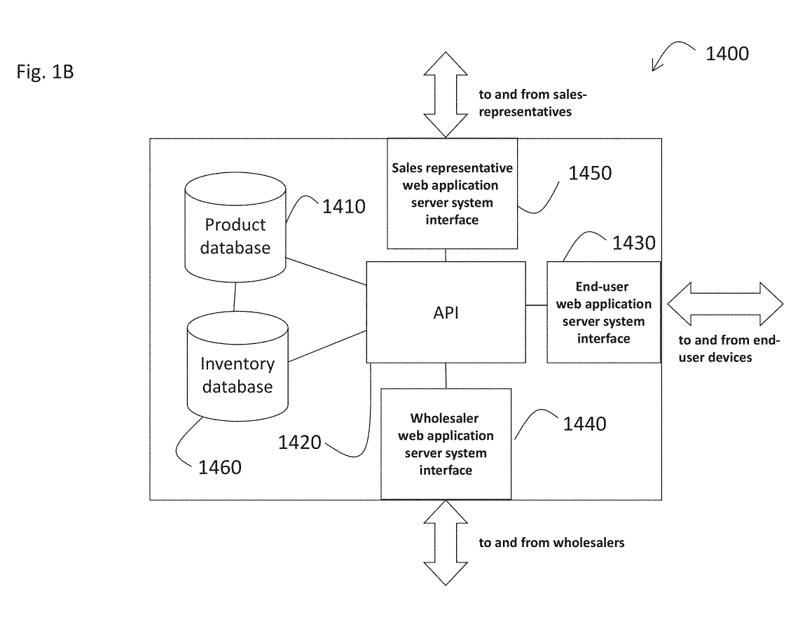

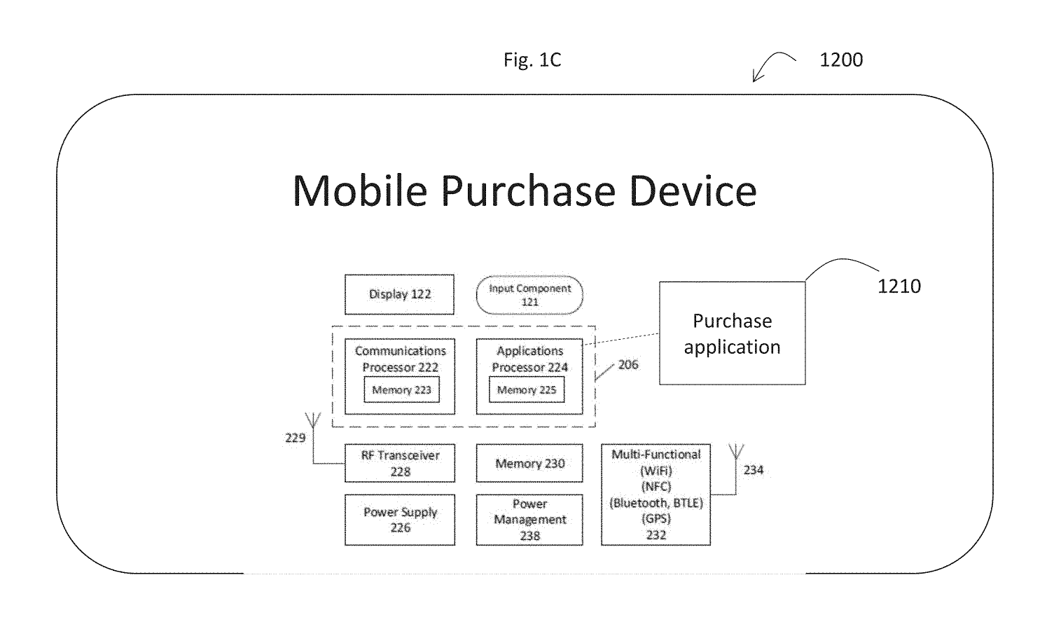

FIG. 1A shows a typical network architecture 1000 in accordance with the present invention. As shown in FIG. 1A, a wholesaler or retailer can access a communications network 1100 (such as the Internet or combinations or individual implementations of private networks and public networks, local area or wide area networks, and so forth) through wholesaler or retailer device 1500. A network-connected server 1400 can include hardware and software, network connections, processors, storage or memory, and others as is typically known in the art. Server 1400 is operable to interface with websites, webpages, web applications, social media platforms, advertising platforms, and others. Sales representative devices 1600, wholesaler or retailer devices 1500, mobile purchase devices 1200 and end user-devices 1300 are network connected through wireless or wired network connections and can include laptop computers, tablet computers, desktop computers, smartphones, video game consoles, set-top boxes or wearable devices such as smart watches or glasses, or other computing devices. Examples of wireless protocols include Bluetooth, cellular, Wi-Fi and other currently known and future developed protocols. Typically these devices have processors, memory, user interfaces such as monitors and input means such as voice recognition, keyboard, mouse, touchscreen, keypad, cameras, power systems, connections or others as known in the art and properly assembled to create operable devices.

FIG. 1B shows a client-server interface according to an example embodiment of the present invention. As shown in FIG. 1B, server 1400 can include a product database 1410 connected to an application program interface API 1420, the API 1420 in turn connected to a wholesaler web application server system interface 1440, an end-user web application server system interface 1430, and a sales representative web application server system interface 1450. API 1420 may instruct the databases to store (and retrieve from the databases) information such as link or URL information, user account information, associated account information, inventory information, product information retailer account information, webpage information, sales information or others as appropriate. In many embodiments, integration with embedded advertising in the form of pop-up windows, banner advertising, or other past, present, or future Internet advertising techniques is contemplated. Many of these advertising techniques can be used in conjunction with the system in order to provide additional monetization of the systems and methods described herein. The databases may be implemented with technology known in the art such as relational databases and/or object oriented databases or others.

As is known in the art, database 1410 can be implemented in software, hardware or a combination of both on one or more devices. Likewise, server 1400 can be implemented on one or more devices in hardware, software or a combination of both. In many embodiments, processors are provided on or associated with servers that can perform calculations and execute instructions stored in non-transitory memory to achieve the objectives and execute the processes described herein and otherwise contemplated. One or more inventory databases 1460 can be used in various embodiments and can be connected to product database 1410 and API 1420. In an example embodiment there is one inventory database 1460 on the backend—even though on the front end, the system is partitioned between different wholesaler and retailer sites. Additionally, a store database (not shown) can track all wholesaler and retailer online boutiques, which can be versions of a single boutique site. Orders can all be tied to the same inventory database 1460.

FIG. 1C shows a mobile purchase device 1200 such as a smartphone or tablet with installed purchase application according to an embodiment of the present invention. In the example embodiment purchase application 1210 can be a software application that is pushed or pulled from a server to a mobile device 1200 and which allows end-users to navigate a web portal. Software can include computer readable instructions stored on non-transitory computer readable media such as computer memory. It should be understood that the systems and methods described herein are not limited to mobile devices but can also be implemented on wired devices. Here, mobile purchase device 1200 can include a display 122 that allows a user to see a visual depiction of the user interface of device such as a smart phone screen that is usually a touchscreen in modern smart phones. In other embodiments display 122 may be a monitor or screen displaying graphical user interfaces (GUI's) that does not have touchscreen operability but has one or more other input component 121 such as buttons, touchpads, or others. Also included is a processing core 206 which may be a single processor or a core of processors that are operable to control and carry out computer processes within device including a communications processor 222 coupled with memory 223 and an applications processor 224 coupled with memory 225 and storing purchase application 1210. Processing core 206 can perform calculations and execute instructions stored in non-transitory memory. Also included can be separate memory 230, RF transceiver 228 with antenna 229, and power supply 226 with power management module 238. Also included can be a multi-functional transceiver 232 which can communicate over Wi-Fi, NFC, Bluetooth, BTLE, GPS, wireless cellular network such as 2G, 3G, 4G LTE, or others or other communication protocols with an antenna 234. As understood by one of skill in the art, these components are electrically and communicatively coupled in an appropriate manner to make a functional device. Other user devices connecting with the system can have some, all or additional components as would be understood in the art.

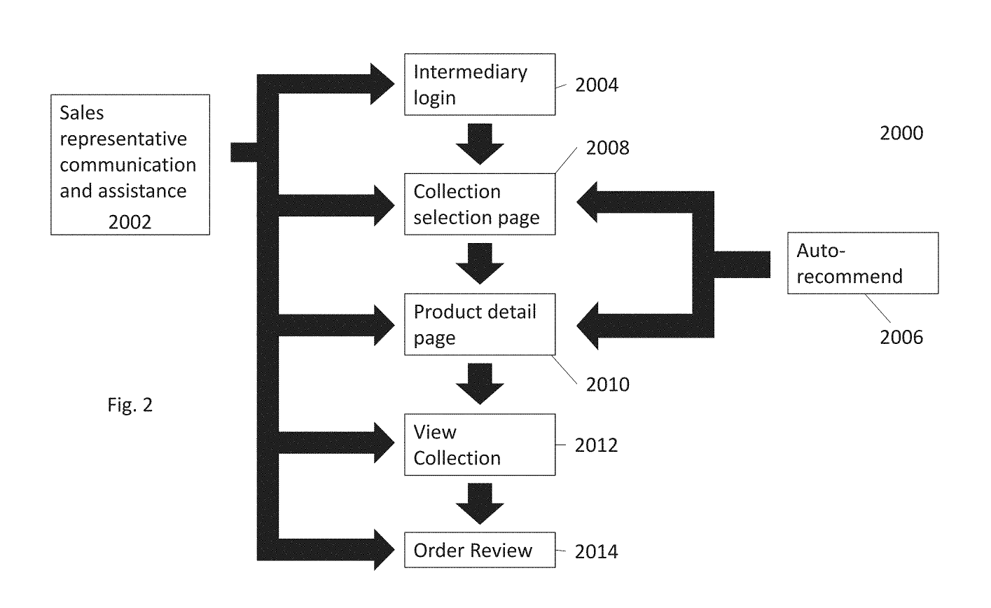

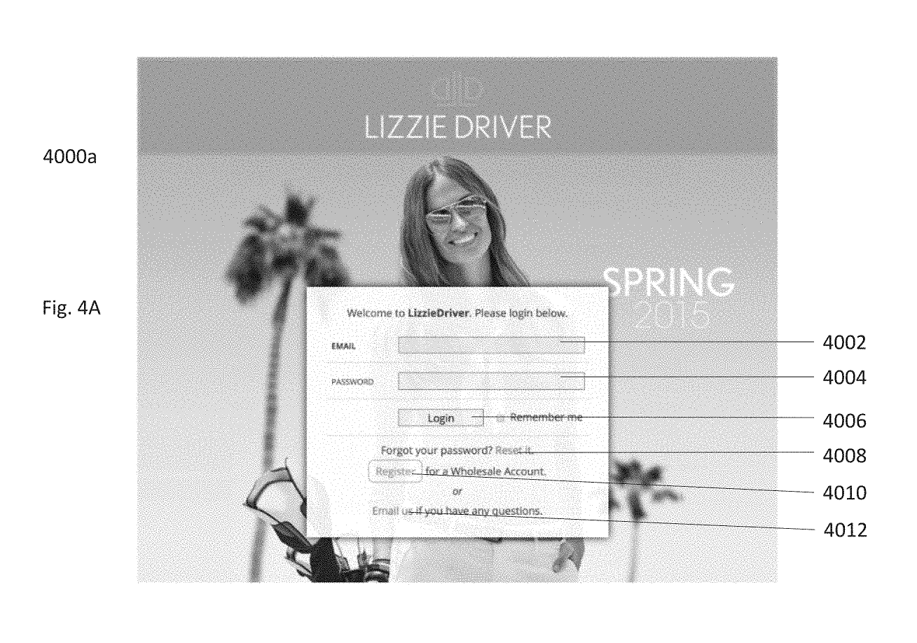

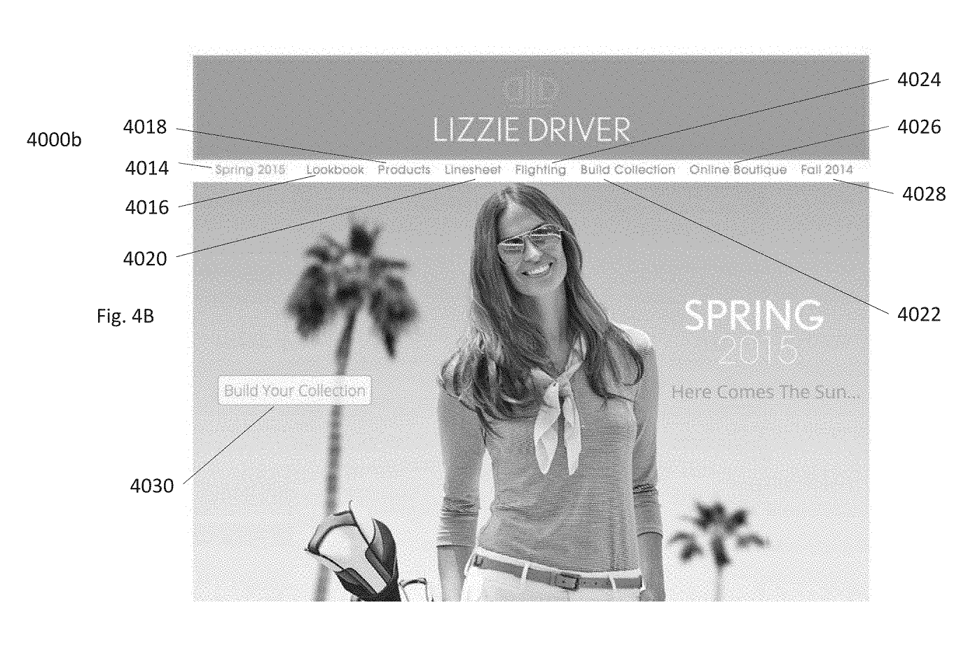

FIG. 2 shows an intermediary selection and order placement flowchart 2000 according to an embodiment of the present invention. From a high level and further described below, in general an intermediary using the system typically logs in, views and makes selections, receives recommendations from sales representatives and the system, and places orders. In the example embodiment, an intermediary can be a wholesaler or retailer and can log into the system 2004 and be sent to a collection section page 2008 before making an item selection and being taken to a product detail page 2010. An auto-recommend feature 2006 can be provided at both 2008 and 2010. A verify collection page 2012 can then be viewed which operates similar to a virtual shopping cart. Upon completion of this verification an order review page 2014 can be displayed. Sales representative communication and assistance 2002 can occur at any of 2004, 2008, 2010, 2012 and 2014. FIG. 4A through FIG. 9 provide example embodiments of these various pages.

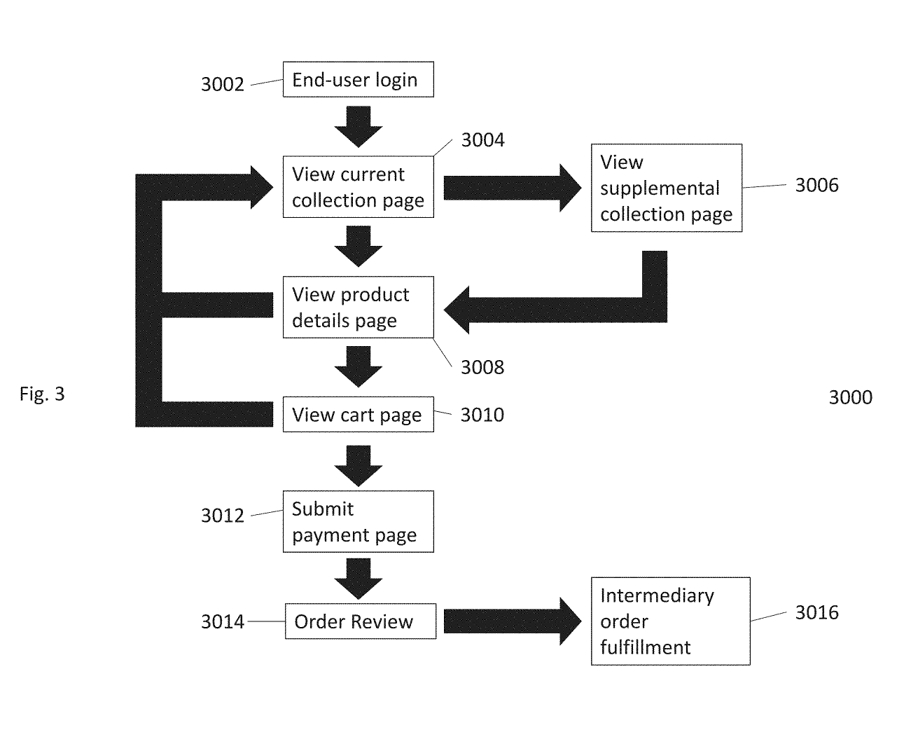

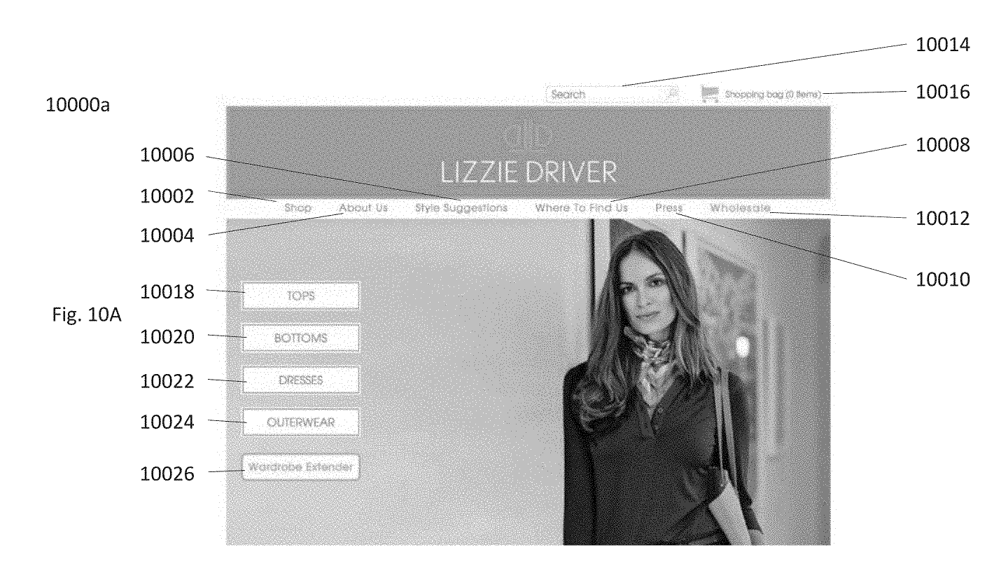

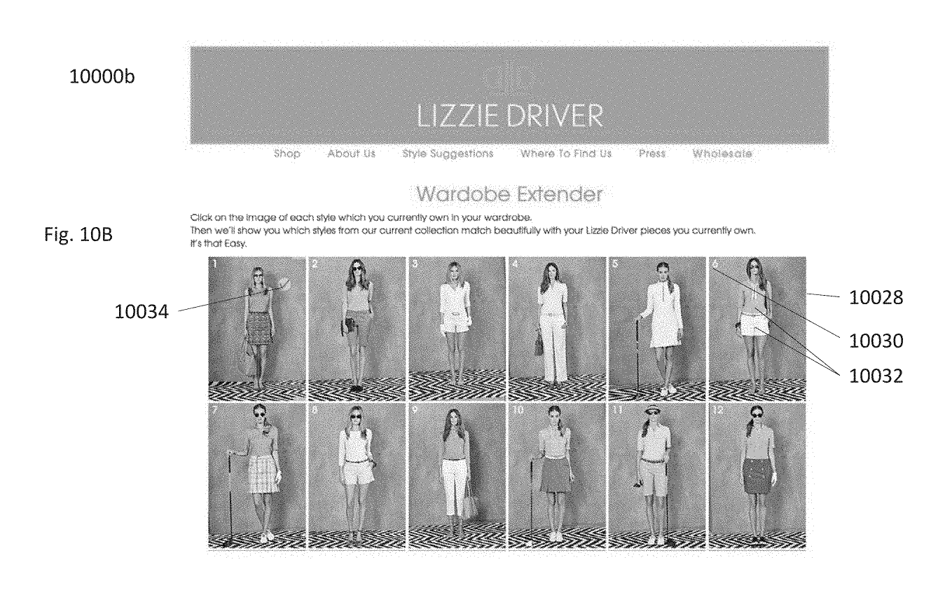

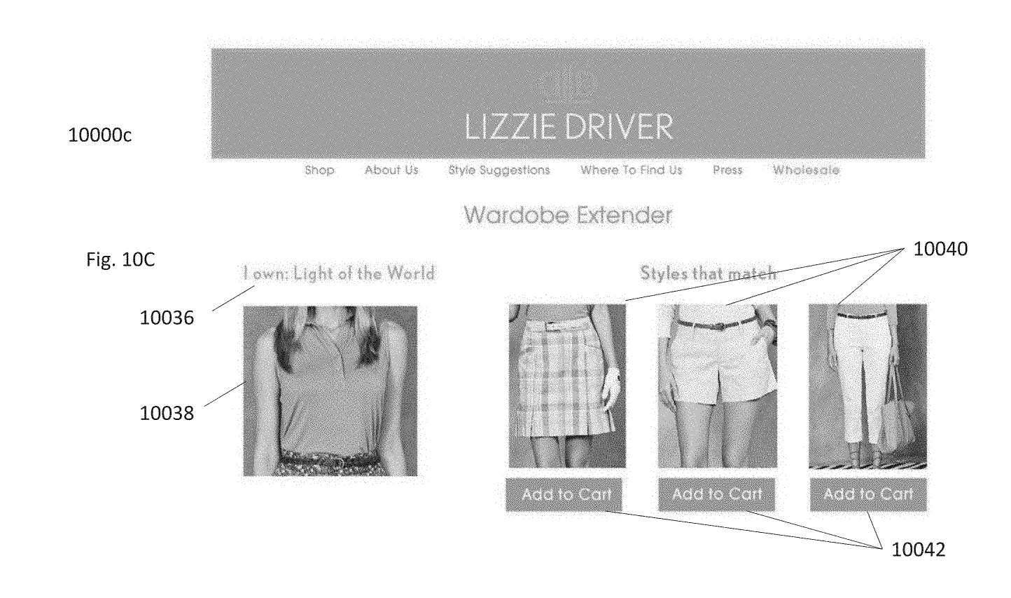

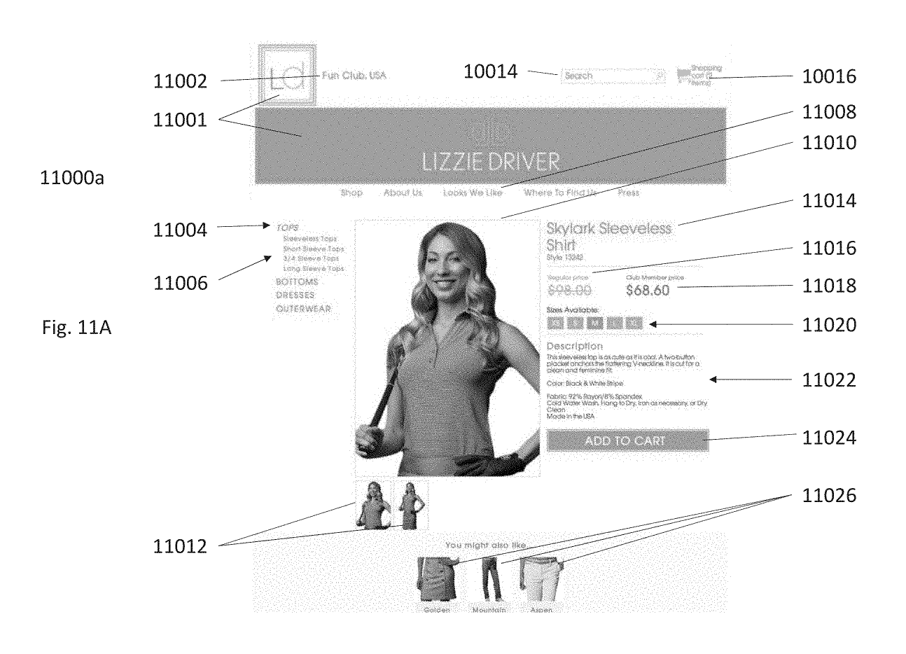

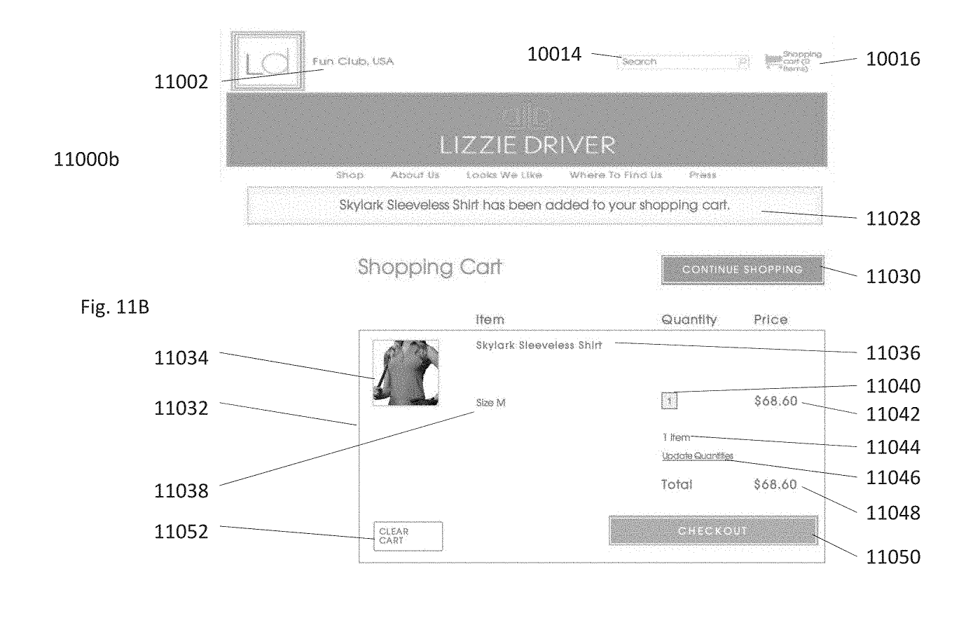

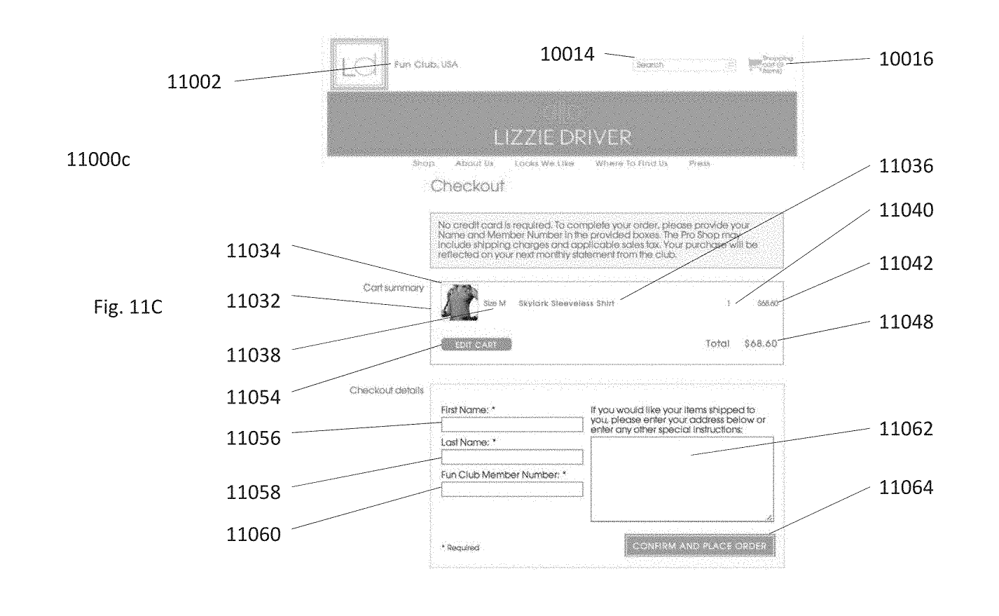

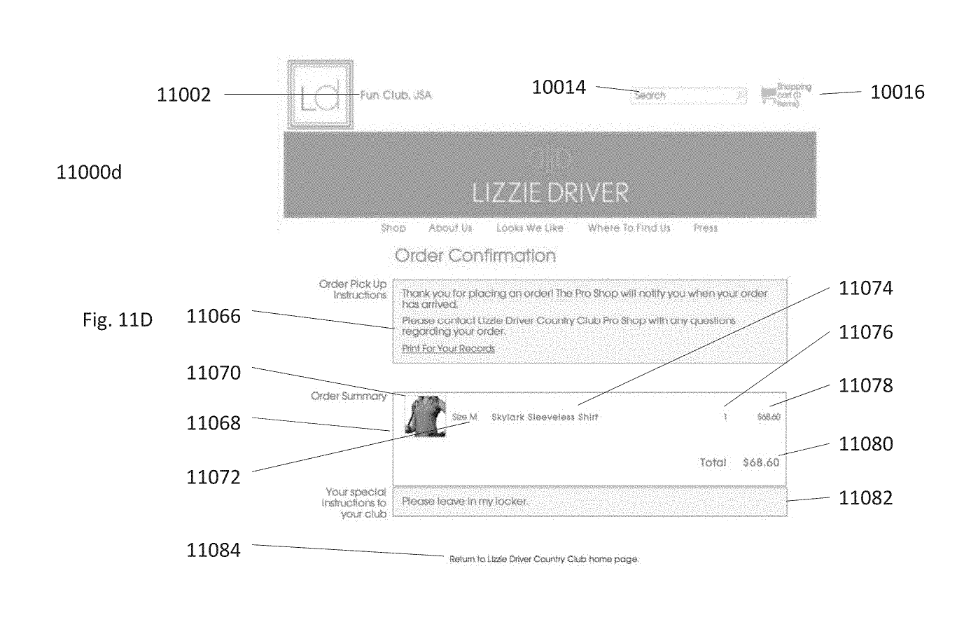

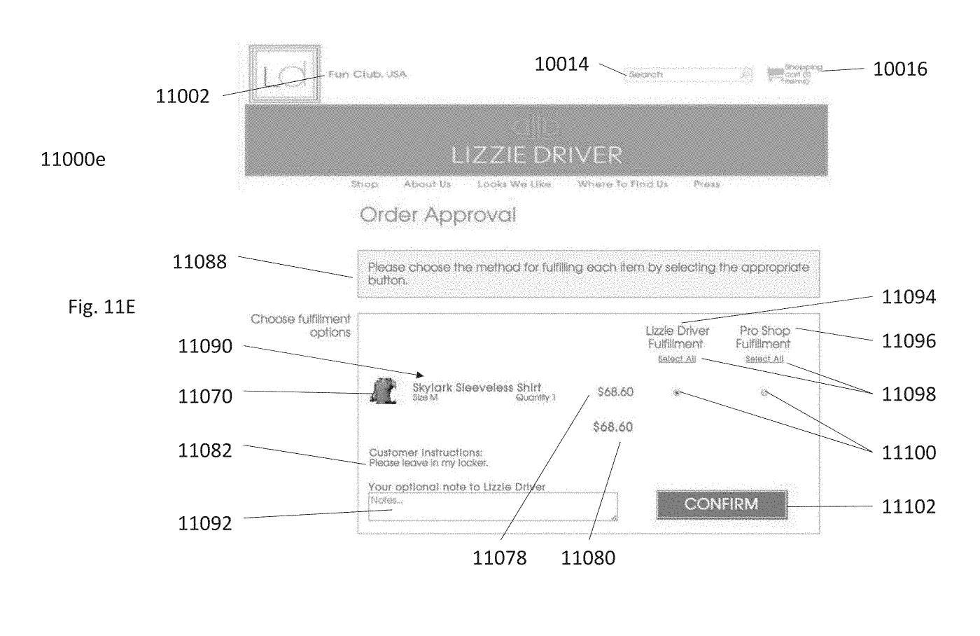

FIG. 3 shows an end-user purchasing flowchart 3000 according to an embodiment of the present invention. From a high level and further described below, in general an end-user purchaser or customer using the system typically logs in, views a current collection from an intermediary, views and selects products for purchase, makes purchases and order fulfillment is begun by the intermediary. Order fulfillment can automatically place an order through the system operator which can cause automatic updates in inventory and billing for both the system operator and the intermediary. In the example embodiment, an end-user can log into the system 3004 and be sent to a view current collection page 3004 before optionally viewing a supplemental collection page 3006. From 3004 or 3006 an end-user can make an item selection and be taken to a view product details page 3008. A view cart page 3010 can be shown after a product has been selected and a user can return to 3004 from either 3008 or 3010. After 3010 a user can be taken to a submit payment page 3012. Upon completion of this verification an order review page 3014 can be displayed before the user is taken to an intermediary order fulfillment page 3016. FIG. 10a through FIG. 11e provide example embodiments of these various pages.

The following outlines an example of an online wholesale process:

1. A Wholesale Cart:

Turning back to FIG. 1, in an example embodiment the system architecture 1000 provides for interaction between a remote sales representative using a sales representative device 1600 and a wholesaler or retailer using a wholesaler/retailer device 1500 while the wholesaler or retailer navigates a wholesale website over a network 1100. In some embodiments no remote sales representative is provided. In embodiments with a remote sales representative, the sales representative can assist the wholesaler in piecing together an order, using a user interface as shown in FIGS. 4A-9. An order can stand on its own or be used to supplement a larger collection of items or inventory which can be stored in a database. System 1000 utilizes a wholesale cart to allow the sales representative and wholesaler or retailer to build and track the wholesaler or retailer's collection. A wholesaler or retailer cart can function similarly to a shopping cart on consumer-facing e-commerce sites.

FIG. 4A wireframe of a wholesaler login page 4000a according to an example embodiment of the present invention. In the example embodiment, a user can log into the system by entering a registered email in email field 4002 and associated password in password field 4004 and then selecting a login button 4006. Other login methods are known in the art such as using a username, unique number or others. If a user has not registered with the system, they can do so by selecting a register button 4010. If a user has questions they can select a contact button 4012 in order to receive customer service.

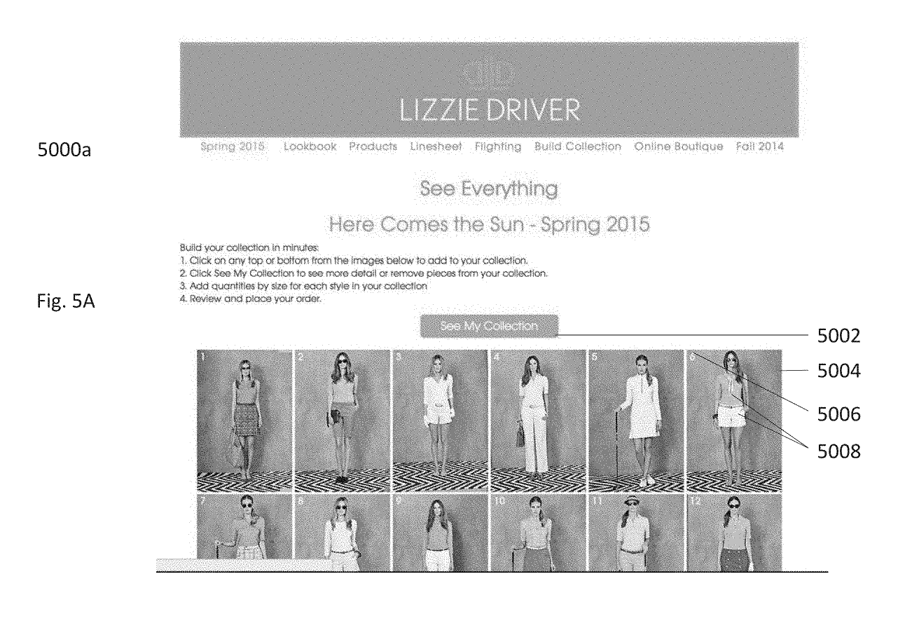

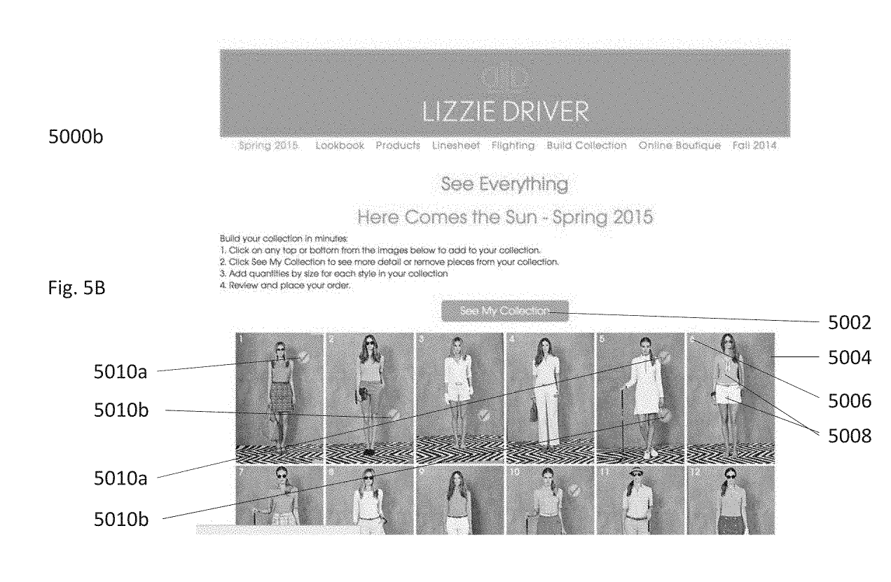

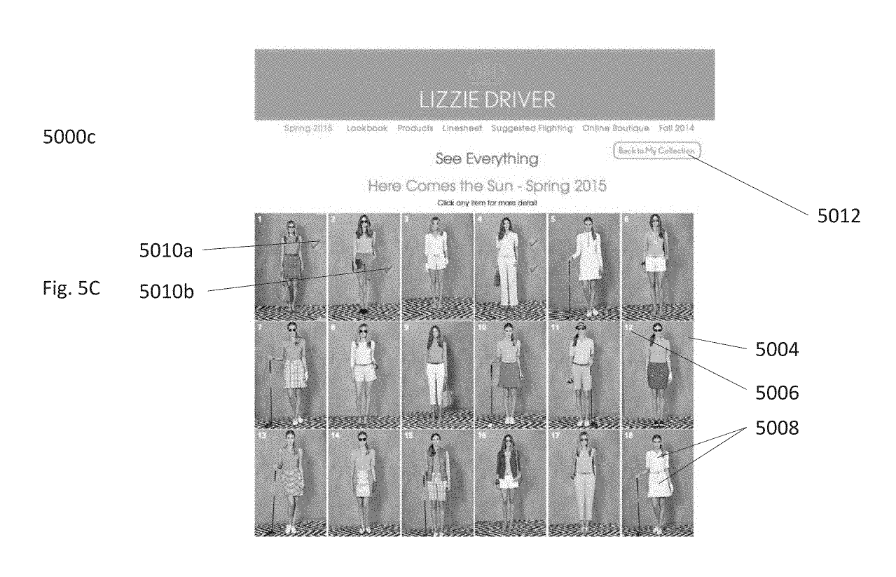

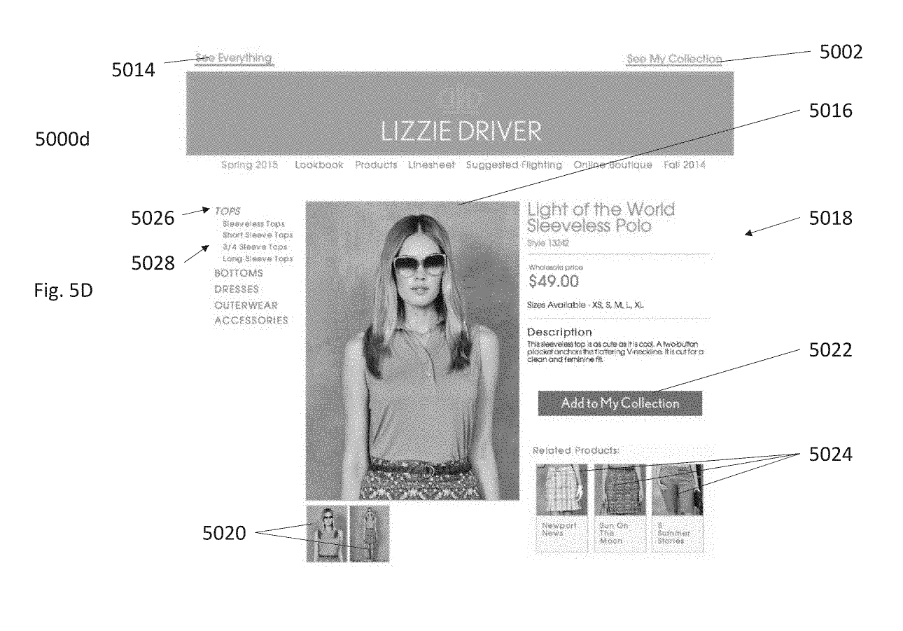

FIG. 4B shows a wireframe of a wholesaler homepage 4000b according to an example embodiment of the present invention. In the example embodiment a logged in wholesaler user can view a currently offered product line by selecting a current products button 4014. As shown, this may correlate with a season, month, particular sale or other appropriate categorization. In the example embodiment, selecting a current products button 4014 provides a view of styles for a season and all navigation buttons to the right (e.g. 4016, 4018, 4020, 4022, 4024 and 4026) reflect that particular season. Selecting a lookbook button 4016 can provide a wholesaler with a view of upcoming product offerings. In the example embodiment, this can include downloading or otherwise displaying a file (e.g. .pdf file) of the seasonal Lookbook or other presentation of lifestyle images for the particular season. Selecting a products button 4018 can provide a user with a current products offering view. In the example embodiment this can include displaying descriptions and images of all products offered for the particular season. Selecting a linesheet button 4020 can provide a user with a view of different product lines to view. In the example embodiment this can include a presentation of all products offered during the particular season and can include details that a wholesaler or other purchaser may desire or require in addition to materials, composition wholesale price and other pertinent information. Selecting a flighting button 4024 can provide a user with a view of flights. In the example embodiment this can include timing of when products for the particular season will be shipped as grouped together in “flights.” As such, selection flighting button 4024 can display a webpage or other listing that represents which products are grouped into a particular flight and when each flight is planned to ship to the wholesaler. Selecting a build collection button 4022 or build your collection button 4030 can provide a user with a view of a “Build a Collection” webpage. In the example embodiment, selection of these buttons can cause the system to display a “Build a Collection” webpage for the specific season, for example as seen in FIG. 5A. Selecting an online boutique button 4026 can provide a user with a view of an online boutique, which will be described in further detail with respect to FIGS. 11A-11E. Selecting a different season button 4028 can provide a user with a view of previous products which have been offered for sale, clearance view, or other past products view. In the example embodiment this can change a products displayed season to Fall 2014.

FIGS. 5A-5C show wireframes of a comprehensive retail items page according to an embodiment of the present invention. As shown in FIG. 5A, the system can initially provide a comprehensive retail items page 5000a with items displayed in a grid, list or other data structure, from which a wholesaler user can select one or more types or styles of items. From a high level, a process of building a collection can include clicking or otherwise selecting items to add to a collection, selecting a see my collection button 5002, adding quantities by size for each item in the current collection, reviewing an order and placing the order. In the example embodiment multiple items 5008 are shown in each style box 5004. Style boxes 5004 are labeled with individual numbers 5006 in order to differentiate them from one another and in order to facilitate customer service. Selection of a see my collection button 5002 can display a view of items that a user has selected with respect to comprehensive retail items page 5000a which the user is considering or otherwise intends to buy.

Selection of particular items from a comprehensive retail items page 5000b and 5000c is shown in the example embodiments of FIGS. 5B and 5C respectively. In the example embodiment a grid of items associated with a seasonal “Spring 2015” collection is shown. Also shown in the example embodiment is functionality providing for multiple items 5008 in a single style box 5004. This is indicated by multiple checkmark symbols 5010a, 5010b in a single box. The checkmark symbol in a circle icon can indicate which items are currently selected, have been previously added to the collection or a combination of both. In the example embodiment, selection of a top garment, for instance by clicking a mouse when held over the selection, is indicated by a checkmark symbol 5010a displayed in an upper area of a style box 5004. Selection of a bottom garment is indicated by a checkmark symbol 5010b displayed in a lower are of a style box 5004.

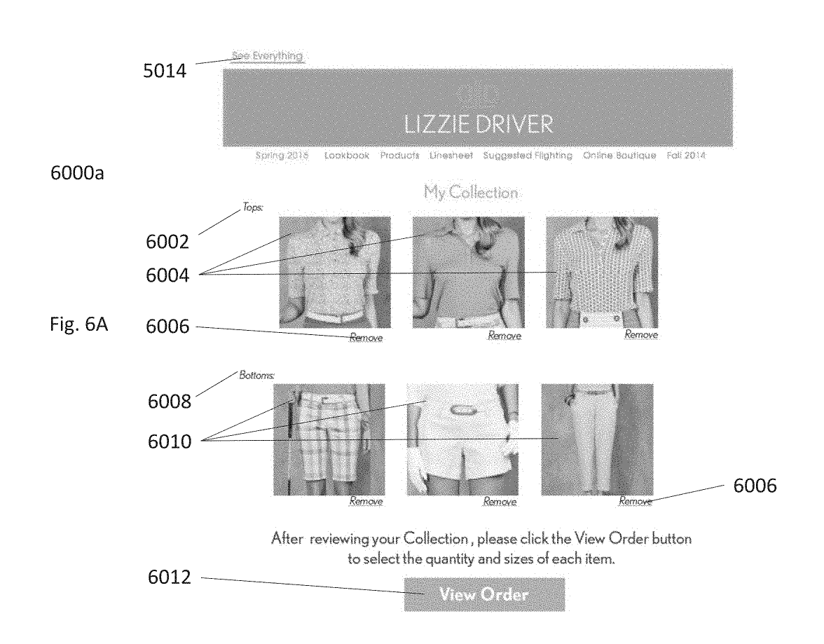

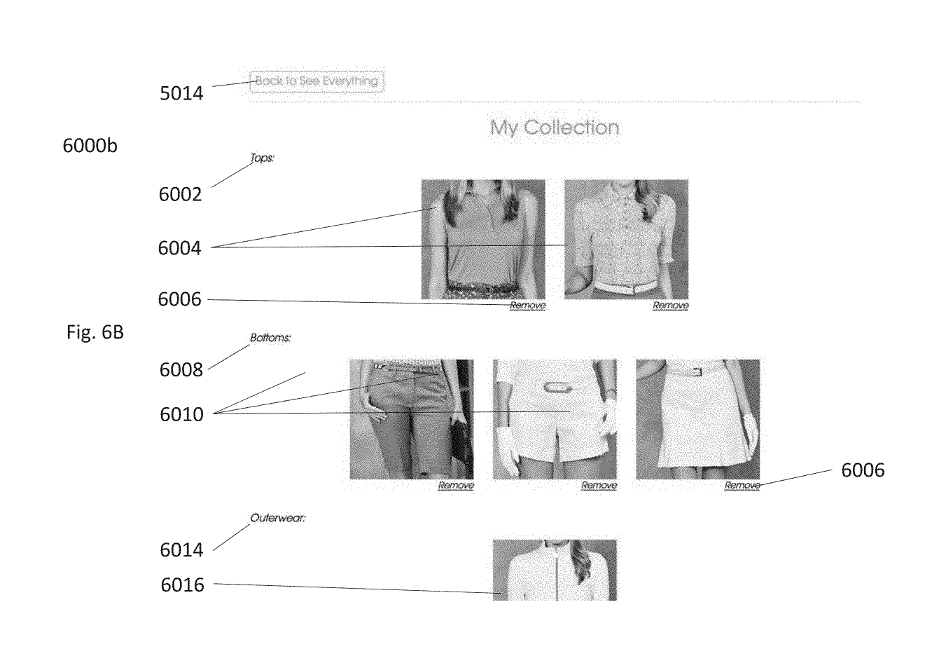

FIG. 5D shows a wireframe of a product detail page 5000d according to an embodiment of the present invention. As in many consumer-facing e-commerce sites, items may be previewed in detail by selecting them in a typical manner, such as double clicking, in order to preview the items. At many points in the process, wholesalers may view the items in the current cart by selecting a current cart button (not shown) and subsequently select desired sizes and select a quantity desired for each size. Items can be easily removed from a cart in many steps of the process by choosing an option to remove (not shown). In many embodiments, buyers are not required to view a product detail page 5000d in order to build a collection, as building a collection can require minimal effort by simply selecting items from a comprehensive retail items page 5000a and proceed directly to a selected items page (e.g. as shown in 6000a of FIG. 6A).

In the example embodiment shown in FIG. 5D, an item is shown in image 5016. Details about the item displayed can be viewed in an item description section 5018. In the example embodiment item description section 5018 shows an item name, style number, wholesale price, list of available sizes and detailed item description. A detailed item description can include features, materials or other pertinent information related to the item that a purchaser may wish to know. Additional views of the selected product are shown in image thumbnails 5020. Related products 5024 are shown in the bottom right corner of the wireframe and are related to the product currently being viewed “Light of the World Sleeveless Polo.” These related products 5024 can be matching, complementary, corresponding or otherwise suggested because of a relation with the selected product. In some embodiments, related products 5024 can include items that are pre-selected by an expert in some embodiments while in some embodiments items can be for items frequently purchased with the currently viewed item. These related products 5024 can assist wholesalers or retailers in compiling a cohesive order with multiple product lines which can have a higher likelihood of attracting multiple end-user purchases than items not chosen related products 5024 offerings by the system. An item category menu 5026 can include categories of items such as Tops, Bottoms, Dresses, Outerwear, Accessories and others. Each category may also include one or more sub-menu 5028. In the example embodiment a sub-menu of category Tops includes Sleeveless Tops, Short Sleeve Tops, ¾ Sleeve Tops and Long Sleeve tops.

Sales Representative Interaction

In many embodiments, sales representative interaction can be important to the overall success of the system although sales representative interaction is not required to start or complete an order in various embodiments. An example embodiment of a sales representative interaction with a golf course pro shop will now be described in detail. In this example embodiment there can be different seasons with different product offerings, such as spring, summer and fall. Each season, a system operator can release a new collection or line of apparel. The system operator can maintain a team of sales representatives that presents the current or upcoming seasonal collection to golf course pro shops over a networked connection or in person.

Initially, a producer or system operator can distribute a seasonal item catalog to individual pro shops. This distribution can occur over a network, for instance by emailing or otherwise making the catalog available on a secure website. A system operator sales representative can then contact a pro shop and log on to the system concurrently with a pro shop operator or purchaser. In some embodiments communications in the form of instant messaging systems, video call boxes, audio connections or other connections facilitate communication between the sales representative and pro shop operator. The sales representative and pro shop operator can browse and search through a grid or other display of available items corresponding partially or wholly to those shown in the catalog. The pro shop operator can select one or more items they are interested in selling in their pro shop. In some instances this selection can cause a redirection of the pro shop operator's web browser to a detail page 5000d where the pro shop operator can view an enlarged image of the selected item and additional item information, as shown in FIG. 5D and described previously. On the detail page 5000d there can be associated or related item 5024 suggestions. In the example embodiment these are bottoms which are matching styles to the top in the image 5016. These suggestions can assist the sales representative in presenting items that complement the currently selected item in the image 5016.

In some embodiments sales representative interaction can be triggered based on incompatible or low probability of success item selections in a single order, as chosen or selected by a producer or other system operator. For instance, in an example embodiment, a pro shop operator could select long pants and wool sweaters for purchase in a summer season. These items would likely have a low probability of selling in summer months when weather is hot and sunny or even humid. Specially tuned triggers or algorithms stored in non-transitory memory and executed by a processor of the system provide a notification to the system operator in the form of a pop-up, email, text message, audio alert or other notification in order to have a sales representative intervene and suggest more appropriate or better suited item choices for a particular implementation. Intervention can occur in the form of a system provided communication interface such as an instant message box that appears on the pro shop operator's display and offers to assist in creating an order.

In an example embodiment, once a pro shop operator has found a product they wish to purchase, they can select an “Add To My Collection” button 5022 which can add the selected item to a purchasing collection which functions as a virtual shopping cart. These steps can be iterative until a desired number of items has been added to the purchasing collection.

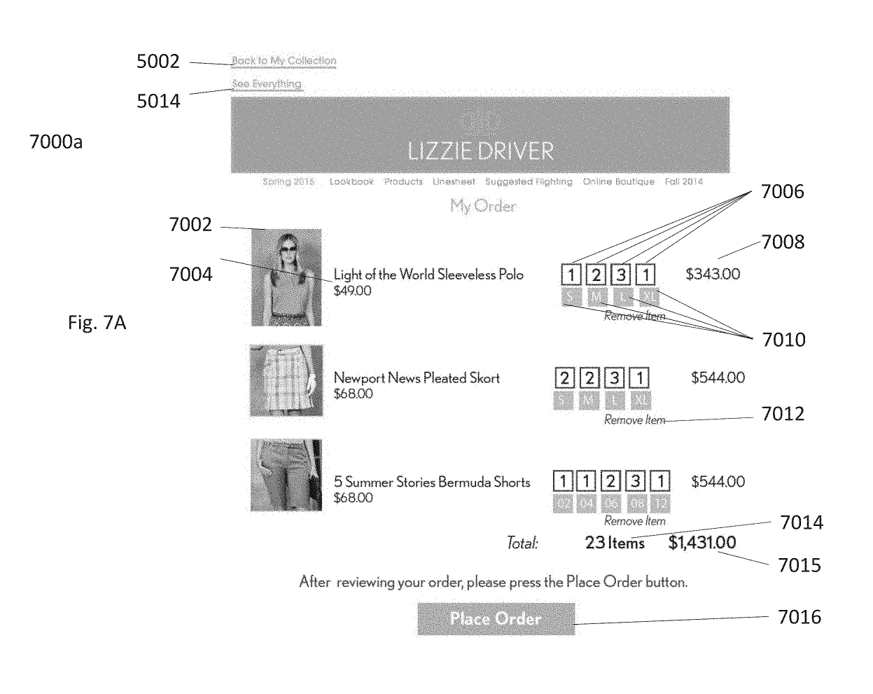

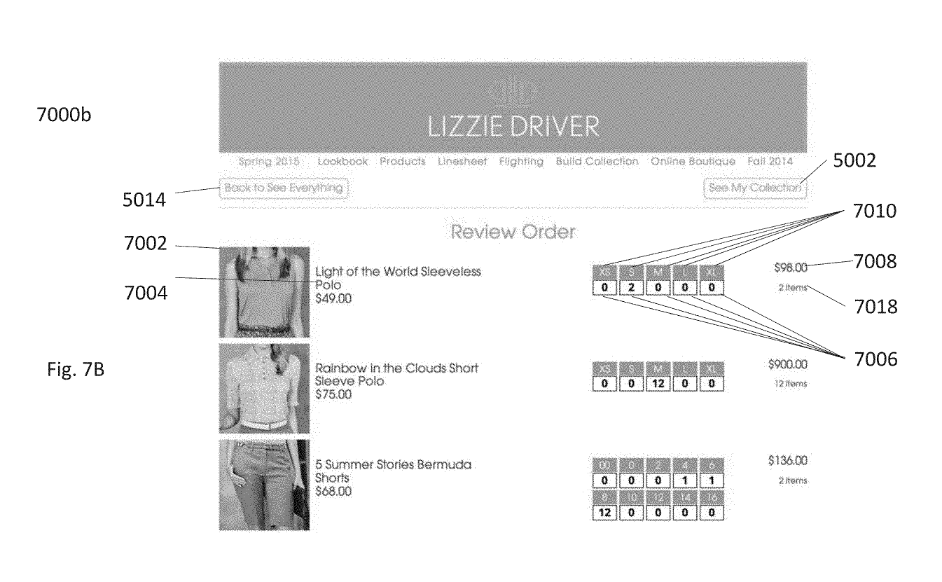

FIGS. 6A and 6B show wireframes of selected items pages 6000a and 6000b respectively, according to textile related example embodiments. When a pro shop operator is ready, they can choose to view the purchasing collection, which can be a “sandbox” environment where items images 6004 in category tops 6002, items images 6010 in category bottoms 6008 and item images 6016 in category outerwear 6014 can be moved and manipulated. Manipulation can include moving, rotating, combining, and other actions. These pages can provide the pro shop operator with an opportunity to determine which items 6004, 6010, 6016 are compatible or matching, to view a quantity of selected items (not shown) and also to remove undesirable or unwanted items from the current collection by selecting a remove button 6006. Sales representatives can also interact with the sandbox environment in order to make recommendations and provide other assistance. Once a pro shop operator is satisfied with a collection, they can select a “View Order” button 6012, which redirects them to a “My Order” page, as shown in FIGS. 7A-7B

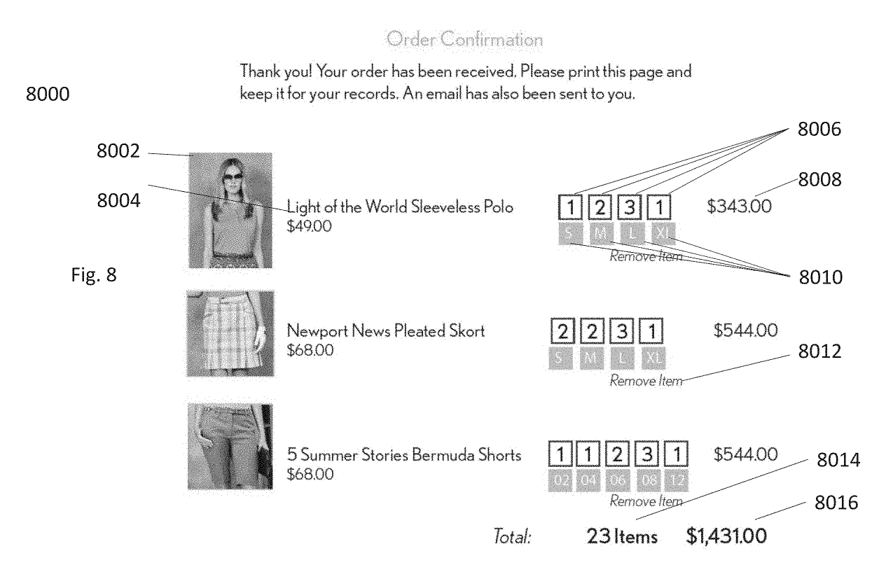

FIGS. 7A and 7B show wireframes of orders pages 7000a and 7000b respectively, according to example embodiments. In the example embodiments, orders pages 7000a and 7000b list the items the pro shop operator has selected for the order. This can include item images 7002 and item details and individual item prices 7004. If any items are unwanted in the current order, the pro shop operator can select a remove item button 7012 in order to have the item taken out of the order. A pro shop operator can select or enter quantities 7006 for corresponding sizes 7010 of each items using an appropriate interface. For example, a pro shop operator can enter quantities 7006 using a keyboard or select quantities 7006 using drop down menus in some embodiments. As such, pages 7000a and 7000b enable pro shop operators to build order sizes. When quantities 7006 are chosen for each item, the system automatically calculates and displays an item quantity price 7008. As shown in FIG. 7B, in some embodiments the system automatically calculates and displays a total item quantity 7018 based on the number of items chosen of a particular style in different sizes. The system also calculates and displays a total order item quantity 7014. Additionally, the system calculates and displays a total order price 7015. This can provide a measure of convenience for purchasers and sales representatives so that they can comply with a desired or required budget. Pro shop operators can select a “Place Order” button 7016 to formally place the order, after which they can be redirected or shown an “Order Confirmation” page as shown in FIG. 8.

FIG. 8 shows a wireframe of an “Order Confirmation” page 8000 according to an example embodiment of the present invention. “Order Confirmation” page 8000 can include a summary of the items including images 8002, item details and individual item prices 8004, sizes 8010 and their corresponding quantities 8010, item quantity price 8008 including a total quantity of items 8014 and a total price 8016. If any items are still unwanted in the current order, the pro shop operator can select a remove item button 8012 in order to have the item taken out of the order.

In some embodiments, the system can monitor the quantity or price of items purchased in a single order or if a number of orders over a particular time period. If the quantity or price of items purchased in a single order or if a number of orders in a time period exceeds a preset threshold, the pro shop can qualify for a custom online boutique website setup by a producer or system operator. For pro shops which may not be technology savvy, this can be beneficial because the system operator performs development work in setting up the website and notifies the pro shop when the site is operating with minimal time and effort on the part of the pro shop. This website can be linked and integrated with the system to provide automatic updates to inventory, statistical analysis of sales and other benefits.

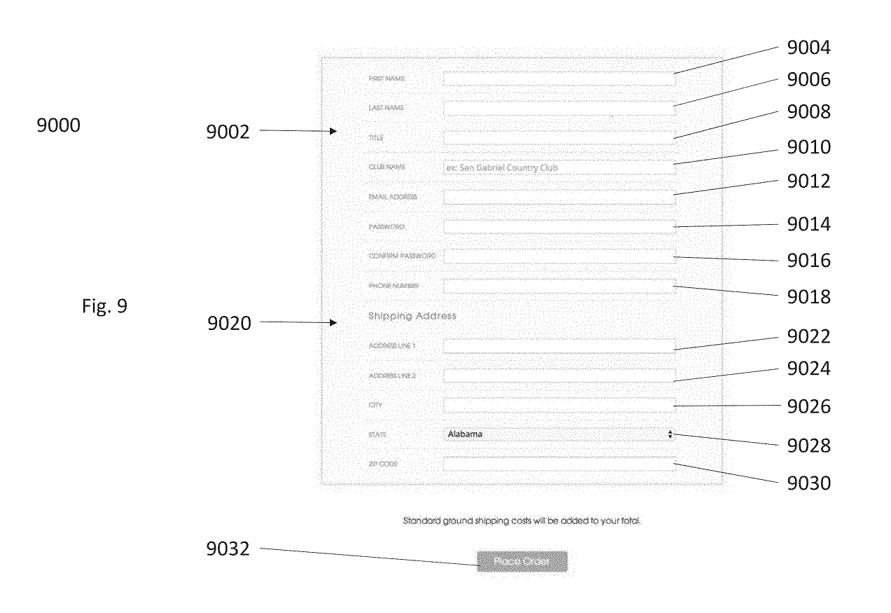

FIG. 9 shows a wireframe of a wholesaler order placement screen 9000 according to an example embodiment of the present invention. In the example embodiment the wholesaler can fill out a contact information section 9002 by entering pertinent information into one or more of a first name field 9004, a last name field 9006, a title field 9008, a pro shop or club name field 9010, a contact email address field 9012, a password field 9014, a password confirmation field 9016 and a phone number field 9018. The wholesaler can also fill out a shipping information section 9020 where they wish to have orders shipped by entering pertinent information into a first address line field 9022, second address line field 9024, city field 9026, state field 9028 and zip code field 9030. In some embodiments but not shown herein, payment information can be entered in pertinent fields as well.

2. A Wardrobe Extender:

In some embodiments of the system described herein, the system can display all products a registered individual consumer has previously purchased. Upon logging in to the system, a registered consumer can select those items that they have bought and currently own. The system can then recommend products from a product listing stored in a product database that complement the items the consumer already owns thus “extending the wardrobe” of the consumer.

To elaborate, as a consumer end-user constructs an order, a dynamic suggestion module can suggest clothing items that complement items which the end-user already owns, based on one or more attributes of the previously purchased items and the current products for sale. These attributes can include color, style, material, fabric, pattern, size, compatibility, season and others. In some embodiments dynamic suggestions can appear in the form of pop-up windows, sliding images into the field of view of the display screen, scrolling to a different portion of the screen and inquiring whether the end-user would like to add related items, flashing, highlighting or changing colors on certain portions of the display or other dynamic means of attracting the end-user's attention. In some embodiments the dynamic suggestion module is implemented using specific triggers, developed for the particular implementation of the system or individual golf club boutique website. For instance, an apparel implementation can implement triggers based on selected patterns, colors or styles of clothing and accessories. Based on an initial selection of a particular blouse with a particular color, printed design and fit to a human body, accessories and other items of clothing can be triggered to accentuate different human form features based on the initial selection.

In some embodiments the system can store a unique list of previously purchased items for each end-user which can then be used to suggest new items with the wardrobe extender feature. In other embodiments the end-user can search through a database or other data structure such as a grid and select items which they currently own and the wardrobe extender can make suggestions based on the selected items. FIGS. 10A, 10B and 10C show wireframes of a wardrobe extender webpage 10000a, 1000b and 10000c respectively, according to example embodiments of the present invention.

FIG. 10A shows an example embodiment of webpage 10000a of the system with a “Wardrobe Extender” button 10026 that an end-user may select to enter a wardrobe extender feature, as shown in FIG. 10B. If a user selects a shop button 10002, a display of items currently on sale will be shown. If a user selects an about us button 10004, a display of information about a system owner will be shown. If a user selects a style suggestions button 10006, a display of matched items will be shown which the system suggests buying together. If the user selects a where to find us button 10008, a display of retail locations, corporate office or other locations will be shown. If a user selects a press button 10010, a display of articles and other publications will be shown. If a user selects a wholesale button 10012, the system will transfer the user to a wholesaler portion of the system, such as that described elsewhere herein. A search field 10014 provides users with the ability to search for particular items by name. If a user selects a shopping bag button 10016, a listing of user selected items for purchase in a current order will be displayed. If a user selects a tops button 10018, a listing of tops for purchase will be displayed. If a user selects a bottoms button 10020, a listing of bottoms for purchase will be displayed. If a user selects a dresses button 10022, a listing of dresses for purchase will be displayed. If a user selects an outerwear button 10024, a listing of outerwear for purchase will be displayed.

Turning to the example embodiment webpage 10000b of FIG. 10B, an end-user can search through a grid, list or other data structure and select items which were previously purchased or are otherwise owned. In the example embodiment multiple items 10032 are shown in each style box 10028. Style boxes 10028 are labeled with individual numbers 10030 in order to differentiate them from one another and in order to facilitate customer service.

As shown in the example embodiment, functionality is provided for selecting multiple items 10032 in a single style box 10028. The checkmark symbol in a circle icon or symbol 10034 can indicate which items are currently selected, have been previously added to the collection or a combination of both. In the example embodiment, selection of a top garment, for instance by clicking a mouse when held over the selection, is indicated by checkmark symbol 10034 displayed in an upper area of a style box 10028. Selection of a bottom garment is likewise indicated by a checkmark symbol (not shown) displayed in a lower are of a style box 10034. As such, multiple items can be selected within a style box 10034 with corresponding checkmark symbols 10034.

Turning to the example embodiment webpage 10000c shown in FIG. 10C, the wardrobe extender can suggest currently offered items to a user to extend a wardrobe the user currently owns based on user selection of particular items that the user currently owns, in this case the “Light of the World” item that the end-user selected as a previous purchase. Description 10036 can include name, size and additional information about the previously purchased and selected item that the user indicated from FIG. 10A, as shown in an image 10038. One or more current items that is matching, complementary or otherwise related or corresponding to the previously purchased and selected item can be shown in images 10040. If a user likes any of the currently offered items, the user can add the item to a shopping cart by selecting a corresponding add to cart button 10042. In doing so, the user can choose to purchase items that complement the user's existing wardrobe and thus create a more cohesive wardrobe in which currently purchased items match with previously purchased and owned items.

In other embodiments the dynamic suggestion module can function differently. In an embodiment where a producer or system operator is a construction hardware manufacturer that produces tools, dynamic suggestions for complementary parts may be made based on standardized part sizes. For example, certain screw types with particular threading may trigger compatible nut, wrench, screwdriver, washer, or other hardware recommendations. Possibilities of implementation for the dynamic suggestion module are as wide-ranging as are producers or system operators in various embodiments. Dynamic suggestion modules and varying other modules in the system described herein can be implemented using specialized processing components, database components or a combination of both which is particularly established to implement the system described herein. In some embodiments this can include facilitating faster processing speed, higher rate of purchasing secondary items and other metrics and objectives.

3. Online Boutique:

FIGS. 11A-11E show example embodiments of wireframes 11000a-11000e of an online boutique.

In some instances, system operators may wish to incentivize or reward wholesalers or retailers for using the system, for example, if the wholesaler or retailer places an order above a certain threshold. In such instances, the system can provide a customized boutique. The customized boutique can be a personalized website for the wholesaler or retailer at a unique URL hosted by the system operator. In the example embodiment, the system operator “Lizzie Driver” 11001 can host a website for retailer “Fun Club” 11002 at a URL: http://www.Lizziedriver.com/Fun-Club. Having an online boutique can enable a wholesaler or retailer to sell to end-user customers in a single, convenient location that is always accessible and open. For some seasonal industries, this can include having an online retail presence year-round, even in off-seasons. Additionally, the added benefit of reaching end-user customers beyond the confines of a wholesaler or retailer's brick-and-mortar locations can provide a much broader customer base which may not otherwise have the opportunity to purchase from the wholesaler or retailer. One benefit for customers is that once a wholesaler or retailer has a customized boutique, customers can have access to every product offered by the system operator and not be limited to the wholesaler or retailer's individual inventory.

In the example embodiment shown in FIG. 11A, a selected item for purchase can be shown in image 11010. An item name and style number 11014 are related to the image 11010. A regular price 11016 can show a full price of an item while a discounted price 11018 can be shown to entice customers to purchase the item. In some embodiments discounted prices 11018 can be unique and customizable for each individual boutique website. As such, each wholesaler or retailer can customize prices and discounts for particular items for their customers. Customers can view item sizes 11020 such as extra small, small, medium, large, extra-large or others. Details about the item displayed can be viewed in an item description section 11022. In the example embodiment item description section 11022 includes a detailed description of the item including colors, washing instructions, fabric types and location of creation. In various other embodiments, other item information can be included such as features, materials or other pertinent information related to the item that a customer may wish to know or which may entice the customer into buying the item. Additional views of the selected product are shown in image thumbnails 11012. Related product images 11026 are shown in the bottom right corner of the wireframe and are related to the product currently being viewed “Skylark Sleeveless Shirt.” These related products 11026 can be part of a wardrobe extender feature in textile embodiments. In other embodiments, a collection extender can be provided. These wardrobe extenders and collection extenders can assist wholesalers or retailers in compiling a cohesive order with multiple product lines which can have a higher likelihood of attracting customer purchases than items not chosen using a wardrobe extender feature. A wardrobe or collection extender can include items that are pre-selected by an expert in some embodiments while in some embodiments items can be for items frequently purchased with the currently viewed item. An item category menu 11004 can include categories of items such as Tops, Bottoms, Dresses, Outerwear, and others. Each category may also include one or more sub-menu 11006. In the example embodiment a sub-menu of category Tops includes Sleeveless Tops, Short Sleeve Tops, ¾ Sleeve Tops and Long Sleeve tops.

In the example embodiment shown in FIG. 11B, a shopping cart page 11000b shows a list of items a customer has selected for purchase in the shopping cart 11032. This can include one or more item images 11034, item names 11036 and item details 11038, quantity of items 11040, individual item prices 11042 which can reflect a particular online boutique's desired discounted price and can be updated automatically, total item quantity 11044 and total price 11048. Also displayed are a quantity update button 11046, a checkout button 11050 and a clear cart button 11052. A continue shopping button 11030 will take a customer back to a shopping area. A recent activity area 11028 will display actions recently taken by the customer.

FIG. 11C shows an example embodiment of a checkout webpage 11000c. This can include a cart summary area with many of the features described with respect to FIG. 11B above. Additionally, an edit cart button 11054 can allow a customer to edit a cart before placing an order. Customers can select a “Confirm and Place Order” button 11064 to formally place the order, after which they can be redirected or shown an “Order Confirmation” page as shown in FIG. 11D.

In some embodiments customers can have a unique member identifier, such as an alphanumeric code or other identifier. The customer can receive this identifier when signing up for the system with a particular wholesaler or retailer. When shopping using the system, the customer can input the identifier whenever the customer makes a purchase. When a customer selects the “checkout” button 11050, the customer can pay using the identifier by entering the number into number field 11060 as shown in FIG. 11C in the “FunClub Member Number” data input field 11060. Customers can also enter their first name into first name field 11056 and last name into last name field 11058 and special instructions into special instructions field 11062. The identifier can allow the customer to gain points or other customer appreciation benefits, even when purchasing items which are not currently in the wholesaler or retailer's inventory of items for purchase.

In some embodiments the online boutique can be further customized or personalized for individual customers by a particular retailer. Usage by particular customers can culminate in delivery of purchased items to individual customer lockers where the customer can retrieve their ordered items. An example embodiment is shown in FIG. 11D where a customer can inform a club to leave items from an order in a locker at the club's brick-and-mortar store while the club can review, confirm and add additional instructions for a system operator as shown in FIG. 11E.

As shown in the example embodiment of FIG. 11D, an “Order Confirmation” page 11000d can be displayed by the system. “Order Confirmation” page 11000d can include order pickup instructions 11066 and an order summary 11068 of the items including images 11070, item details 11074 including a name, item size and individual item prices 11078, and corresponding quantities 11076, and a total price 11080. Also displayed are an instructions field 11082 and return to home page button 11084. An email with similar information can be sent to a system operator, retailer, customer and combinations thereof in some embodiments automatically upon confirmation of the order by selection of the confirm and place order button 11064 of FIG. 11C.

In some embodiments, in lieu of a credit card or other payment alternative, a customer enters their identifier to purchase an item and the purchased item is delivered to an individual locker, such as a locker at the associated retailer's location. The identifier can be associated with the customer in a database and the customer can be billed in an automated monthly statement.

In FIG. 11E, an example embodiment of an order approval screen 11000e is shown. When a customer places an order the retailer can be notified, such as by email, text message, or other notification means. The retailer can click a link or log on to the system which and access a “Pro Shop Administration” or other retailer administration page such as order approval screen 11000e where they can verify payment, order and delivery information of the customer who placed the order. In the example embodiment a retailer can view customer instructions as shown in instruction field 11088. An order fulfillment for the order placed can include item images, 11070, description area 11090 including quantity, size and item title, individual item price 11078, total order price 11080, special instructions 11082 and notes field 11092.

The retailer can also select whether they will fulfill the order in their store or other retail establishment or, if the item is not in stock at the retail location, the retailer can select a system operator notification button. This button can send an indication or otherwise notify the system operator that the associated item requires shipment directly to the customer or to the retailer for customer pick-up. In some embodiments orders may have split fulfillment, where part will be fulfilled by the retailer and part will be directly shipped from the system operator directly to the customer or to the retailer for the customer. As such, retailers can select fulfillment options such as system operator fulfillment 11094 or retailer or pro shop fulfillment 11096. Where multiple items have been purchased, a retailer can select a select all button 11098 to have all items fulfilled by an associated choice. Radio buttons 11100 can provide the selection while a confirm button 11102 allows the retailer to confirm the order. An email reflecting the information on this screen can be sent to a system operator and retailer in some embodiments automatically upon confirmation of the order by selection of the confirm button 11102 of FIG. 11E.

In controlling systems and performing processes as described above, general purpose or dedicated “firm ware,” computer hardware and software stored in non-transitory computer readable media may be used or otherwise adapted. Firmware will typically include non-transitory memory (in the form of a programmable hard drive, RAM, etc.) for the storage and execution of instructions contained therein or thereon.

Various features described herein can be understood to be modules which can be grouped together as larger modules. For example, an intermediary module can include features of intermediary interaction with the system described herein while an end-user module can include features associated with end-user interaction with the system described herein. In some embodiments, some modules can include one or more other modules.

The subject methods, including methods of use and/or manufacture of the hardware described, may be carried out in any order of the events which is logically possible, as well as any recited order of events. Also, it is contemplated that any optional feature of the inventive variations described may be set forth and claimed independently, or in combination with any one or more of the features described herein.

Though the invention has been described in reference to several examples, optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention.

Reference to a singular item includes the possibility that there are a plurality of the same items present. More specifically, as used herein and in the appended claims, the singular forms “a,” “an,” “said,” and “the” include plural referents unless specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the claims shall allow for the inclusion of any additional element-irrespective of whether a given number of elements are enumerated in the claim, or the addition of a feature could be regarded as transforming the nature of an element set forth in the claims. Except as specifically defined herein, all technical and scientific terms used herein are to be given as broad a commonly understood meaning as possible while maintaining claim validity. Accordingly, the breadth of the different inventive embodiments or aspects described herein is not to be limited to the examples provided and/or the subject specification, but rather only by the scope of the issued claim language.

What is claimed is:

1. A network connected system for inventory management including:
a server communicatively coupled to the network and having instructions stored in non-transitory memory which, when executed by a processor of the server, cause the processor to:
display an intermediary module user interface to an intermediary over the network, including an intermediary item sales platform user interface and an intermediary inventory management platform user interface, wherein data for the intermediary item sales platform user interface is stored in a product database and data for the intermediary inventory management platform user interface is stored in an inventory database for intermediaries, wherein intermediaries include wholesalers and retailers; and
display an end-user module user interface to an end-user over the network, including a first end-user item sales platform associated with a system operator and a second end-user item sales platform associated with an intermediary.

2. The system of claim 1, wherein displaying the intermediary module user interface further comprises:
displaying a wholesale cart for an order which, upon selection of a first item for purchase using a user input by a wholesale user, retrieves first item data from a product database and displays at least one selected, stored secondary item data for inclusion in the order as an item recommendation to the wholesale user at the intermediary module user interface based on system identification that the selected, stored secondary item has a matching characteristic with the first item which is likely to increase sales of the first item, at least one selected, stored secondary item or combination thereof.

3. The system of claim 1, wherein displaying the intermediary module user interface further comprises:
displaying a sales representative communication interface to the intermediary, whereby the intermediary can interact with a sales representative of the system using one or more of audio, visual, audio-visual and textual interfaces in real-time.

4. The system of claim 1, wherein displaying the intermediary module user interface further comprises:
creating the second end-user item sales platform associated with an intermediary for a first intermediary after the processor determines that the first intermediary has reached a sales or purchasing threshold stored in a database, including:
for the first intermediary, assigning a unique network address to the second end-user item sales platform associated with the first intermediary;
associating data from the inventory database for intermediaries associated with the first intermediary with the second end-user item sales platform associated with the first intermediary; and
displaying the second end-user item sales platform associated with the first intermediary upon an end-user accessing the unique network address over the network, wherein the end-user can select and purchase items using an end-user input through the second end-user item sales platform associated with the first intermediary and upon confirmation of a purchase by the end-user, automatically notify the first intermediary of the purchase by sending an electronic communication with data associated with the purchase to the first intermediary over the network.

5. The system of claim 1, wherein displaying the end-user module user interface further comprises:
displaying a wardrobe extender platform user interface including:
upon a self-identified indication that a first item was previously purchased by an end-user selection, retrieving at least one pre-selected wardrobe extending second item from the product database after system identification of at least one matching characteristic between the first item and the second item; and
displaying the second item to the end-user at an end-user interface.
